(19) United States
(12) Patent Application Publication
(10) Pub. No.: US 2003/0182196 A1
(43) Pub. Date: Sep. 25, 2003

(54) Taxonomy based user interface for merchant comparison in electronic commerce system

(76) Inventor: Jun Huang, San Jose, CA (US)

Correspondence Address: GLENN PATENT GROUP, 3475 EDISON WAY, SUITE L, MENLO PARK, CA, 94025, US

(21) Appl. No.: 10/103,639

(22) Filed: Mar. 20, 2002

(51) Int. Cl. G06F 17/60

(52) U.S. Cl. 705/26

(57) ABSTRACT

A shopping “front end” component for an online merchant system together with other components enables an OSP to facilitate the online commercial transactions of its Users. The shopping front end component includes a navigable GUI that adopts characteristics of the interactive online experience that the OSP has previously presented to its Users. Such characteristics will include the OSP's its trade dress, navigable characteristics, and taxonomy. The navigable GUI also includes product identifiers within database access and retrieval programming for each commerce item sold through the merchant system, the product identifiers having been previously associated with commerce item information entries in a database.

### BACKGROUND OF THE INVENTION

The present invention relates to a user interface and the use of product identifiers in an electronic commerce shopping and merchandising system.

### DESCRIPTION OF THE RELATED ART

The World Wide Web (“Web”) is part of a global computer network known as the Internet through which Online Service Providers (“OSPs”) 1, such as Microsoft Network, CompuServe, Prodigy and America Online, enable on-line users (“Users”) of OSPs 1 to link to Web sites of various online entities. See FIG. 1. Users may access the Web sites of a variety of online entities to retrieve various content as well as purchase products and/or services from distinct online entities. Users may directly access the online merchant systems of distinct vendors 3 on the Web and also the online merchant systems of eCommerce Aggregators 4. Online eCommerce aggregators 4 access, search and retrieve product information from various vendor databases to provide a comparison shopping mechanism for Users of the aggregator's 4 Web site.

A Web based online merchant system enables an online entity, such as a vendor 3 or aggregator 4, to particularize the Web site pages that display and describe its product or services (i.e. “commerce items 34”) to Users. The online entity determines the layout and display of Web site pages having descriptive content including text, images, sound and video. The general manner of creating Web site content using HyperText Markup Language (HTML) and delivering it to Web browsers is well known in the art. Users may access an online entity's merchant Web site using a Web browser (e.g. Netscape Navigator), installed on a client connected to the Web through an OSP 1. The User's Web browser loads and interprets the HTML to format and display the online entity's Web page for the User's Web browser. An online merchant system may also provide a User interface (e.g. GUI) to enable shoppers to navigate a online entity's site and identify commerce items 34 of interest, obtain specific information regarding commerce items 34, and to electronically purchase commerce items 34.

For the purpose of this application, a vendor 3 is considered to be any online entity that engages in commercial transactions involving commerce items. Vendors 3 typically store information (i.e. “vendor item information 33”), related to its commerce items 34 such as product descriptions, specifications, prices and images, in relational databases. Relational databases are well known in the art and generally comprise a logical design structure (i.e. a schema) that defines the groupings (e.g. tables) of data, the distinguishing characteristics (e.g. attributes) of that data, and the relationships between different groupings of data in a vendor database 31. Once the vendor's database schema is designed, the vendor 3 may use a database management system, also well known in the art, to build and administer its database. Thus, vendors 3 typically create an internal proprietary schema to organize and manage their databases 31.

Most commercially available online merchant systems require that vendors 3 organize vendor item information 33 in databases 31 according to a predefined schema. Thus, because various vendors 3 organize their item information 33 according to proprietary database schemas, to use these systems a vendor 3 must either convert its existing database 31 to a different and predefined schema, or the vendor 3 must create a new database 31 having the predefined schema. Either option requires substantial efforts and costs which may indirectly force vendors 3 to compromise their database design and management. Compromised database design or management will very likely adversely effect a User's online shopping experience and thereby decrease the likelihood that the User will purchase commerce items 34 from the vendor 3 or even return to the vendor's Web site. Still other vendors 3 may simply forego making their databases 31 available to Users because of the cost of implementing a high quality merchant Web site. It would therefore be desirable for vendors 3 to provide means to easily modify existing databases 31 thereby facilitating access to another online reselling or transaction facilitating entity such as an OSP 1 or an aggregator 4.

A further problem for online merchants is the difficulty of drawing Users to their Web sites, keeping them there, and also generating return traffic. Online merchants typically advertise to draw Users to their Web sites. Keeping Users interested and generating return User traffic most often requires that Users have a successful online experience at a Web site. However, a successful online experience at a Web site generally requires that Users be able to quickly find information regarding the commerce items 34 that they are looking for. Thus, an unsuccessful shopping experience due to compromised vendor database design or management will be further exasperated by a User's unfamiliarity with the vendor's Web site design methodology including its taxonomy, or what might otherwise be described as the vendor's online “look and feel” or trade dress.

On the other hand, the success or quality of a User's online experience at a particular Web site generally increases as Users grow more familiar with the Web site design methodology, navigable characteristics, and taxonomy. Many OSPs 1 having this realization have transcended the basic Internet access services provided by simple Internet Service Providers and now offer complementary value added services together with a consistent online look and feel to their Users. As a result, many OSPs 1 have developed the trust of a significant number of Users who appreciate the additional services but also expect and appreciate the consistent online experience that many OSPs 1 provide. It follows that Users are more likely to have successful online experiences by remaining within an OSP's 1 Web site rather than venturing onto the Web and away from the OSP's 1 Web site, particularly when the User desires to shop for commerce items 34 from various vendors 3. Thus, it would be desirable to provide a shopping and merchant comparison User interface that leverages a User's familiarity with the online look and feel of an online entities Web site.

### SUMMARY OF THE INVENTION

A typical system implementing the invention will include both hardware and software systems. Included in the hardware and software system are those components necessary to provide Web access to Users. Such Internet infrastructure hardware and software systems are readily available and their operation and design are obvious to those of ordinary skill in those arts.

The invention enables OSPs 1 to improve a User's online shopping experience by leveraging its User's familiarity with a previously existing Web site interactive experience that includes the OSP's 1 trade dress, navigable characteristics, and the taxonomy. One aspect of the present invention comprises a shopping “front end” component for an online merchant system that together with other components enables an OSP 1 to facilitate the online commercial transactions of its Users. The shopping front end component comprises a navigable GUI 37 that adopts characteristics of the interactive online experience that the OSP 1 has previously presented to its Users. Such characteristics are contemplated to include the OSP's 1 its trade dress, navigable characteristics, and taxonomy.

Another aspect of the invention associates a Product Identifier (“PID”) 50 with each vendor item information 33 entry associated with a commerce item 34 sold through an online merchant system. PIDs 50 are generated by a methodology or an algorithm that reflects similarities and/or differences in vendor item information 33 entries in a database. PIDs 50 are equivalent for “similar” or competitive commerce items 34 in a first embodiment and further include at least one unique portion in another embodiment. The invention contemplates the local or remote generation of PIDs 50 according to a communicable standard, methodology, or algorithm and may be by the original vendor 3 of the commerce item 34, an aggregator 4, or an OSP 1.

As a result of the introduction of PIDs 50, another aspect of the navigable GUI 37 includes PID 50 based database access and retrieval programming or functionality that efficiently and successfully accesses a database comprised of vendor item information 33 entries and PIDs 50. A database for use with the invention includes either a composite database 32 or a plurality of distinct databases 31 comprised of vendor item information 33 entries and PIDs 50 that may be remote to the OSP 1, distributed between the OSP 1 and the vendors 3, or entirely local to the OSP 1.

### BRIEF DESCRIPTION OF THE DRAWINGS

FIG. 1 depicts a block diagram of the Web illustrating the context of the present invention;

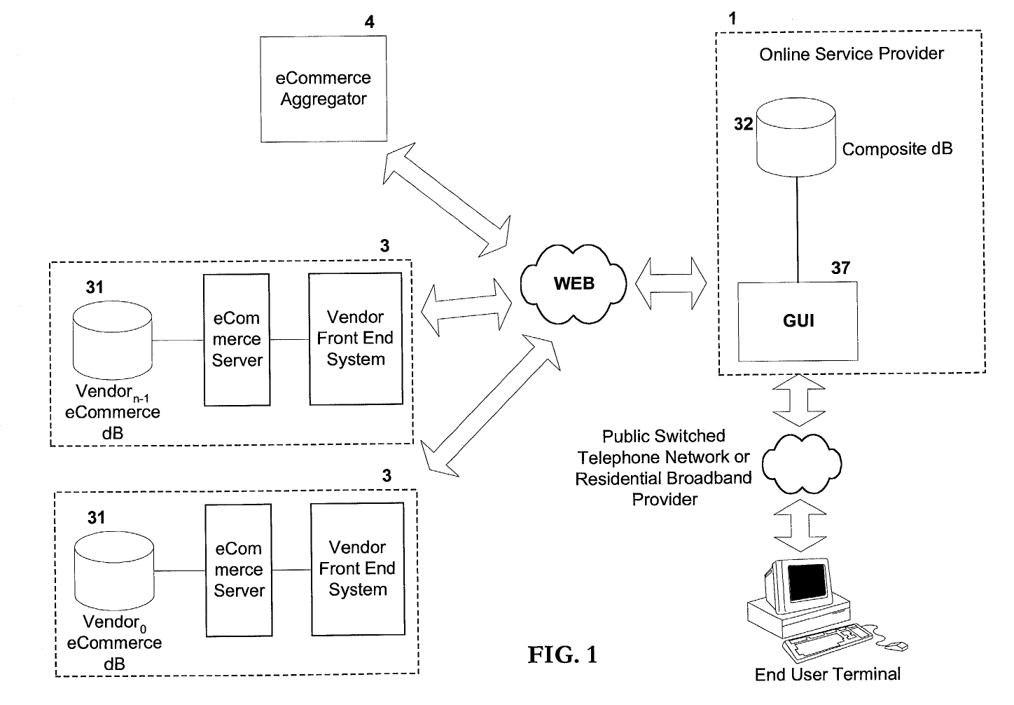

FIG. 2 depicts a state diagram of an embodiment of a navigable state machine; and

FIG. 3 depicts a methodology for generating product identifiers for vendor item information entries.

### DESCRIPTION OF THE PREFERRED EMBODIMENTS

The preferred merchant shopping and comparison system front end comprises a GUI with navigable states. The state navigable GUI 37 adopts an online entity's previously developed trade dress including its previously developed taxonomy that has become familiar with the OSP's 1 Users. The state navigable GUI 37 enables User initiated access to a composite of vendor databases 32, or plurality of distinct vendor databases 31. In either instance, the database having been previously modified to associate PIDs 50 with at least a portion of the vendor item information 33 entries.

Although the development and online deployment of the state navigable GUI 37 is OSP 1 controlled, PIDs 50 may be generated and assigned within the databases, 31 and/or 32, by the original vendors 3, or an OSP 1. Moreover, regardless of what online entity manages the database, 31 and/or 32, or where it is physically located, facilitated access between the OSP's 1 state navigable GUI 37 and each vendor's item information 33 entries is enabled by the inclusion of PIDs 50 within the database, 31 and/or 32.

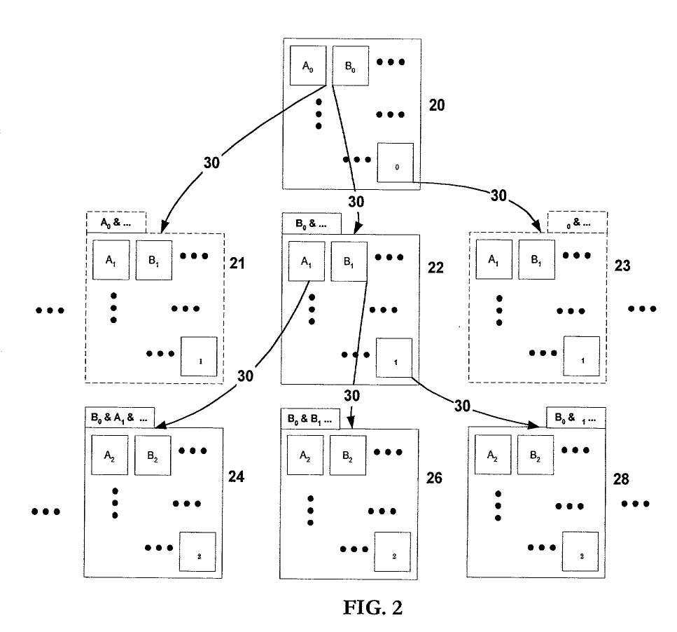

Preferably, an OSP 1 that has developed a state navigable GUI 37 with a consistent online experience for previously offered online services will adopt an equivalent trade dress for the state navigable GUI 37 for its online merchant system. The state navigable GUI 37 is formatted as a HTML Web page deliverable to the User's Web browser. FIG. 2 presents an embodiment of a state diagram for software implementing a state navigable GUI 37. Each navigable state 20, 21, 22, 23, 24, 26, 28 exists within a hierarchical state tree with, for example, state 20 representing the root level of the tree structure from which all other states of the tree structure are navigable. A transition or navigation 30 to a different state generally comprises User initiation of a hyperlink that is interpreted by the Web server software to deliver the HTML content representing the next state on the User's Web browser. In this manner, a User may traverse the hierarchical state tree to find an familiar element of the OSP's 1 trade dress representing the User's shopping interest.

The OSP's 1 trade dress preferably includes both the navigable characteristics of its previously existing GUI, such as that described above, and also the previously developed OSP 1 taxonomy which has become familiar to the User through previous visits to the OSP's 1 Web site. In the state navigable GUI 37 depicted in FIG. 2, the navigable hyperlinks within each state—represented by a capital letter and subscript (e.g. B₀, A₁, B₁, . . . )—are represented to the User as elements of the OSPs 1 taxonomy. Moreover, each navigation 30 will comprise the same navigable characteristics embodied in other potions of the OSP's 1 Web site.

In the example given in FIG. 2, the root states 20 (i.e. parent classes) will be represented to the User by the elements of the OSP 1 taxonomy that are relatively broad categorical descriptions. Each state below (i.e. child class), 21-28, is represented to the User as an element of the OSP 1 taxonomy that is more specific relative to its transitional parent class. And finally, relatively equivalent classes (i.e. sibling classes) 24, 26, 28 at the same level are represented by elements of the OSP's 1 taxonomy.

A database query may be initiated upon the Users navigation to a state that most accurately represents his or her commerce item 34 item of interest. In a first embodiment, each state within the state navigable GUI 37 is associated with database access and retrieval programming that retrieves vendor item information 33 entries from a database, 31 or 32. This embodiment includes PIDs 50 in the search expression as an alternative and therefore facilitates the use of the state navigable GUI 37 with databases, 31 or 32, that have not been modified to include PIDs 50. In another more preferred embodiment, the database access and retrieval script 35 includes at least one PID 50 that has been previously determined for, and associated with, the vendor item information 33 in the database, 31 or 32.

The database access and retrieval programming for each navigable state preferably includes a database access and retrieval script 35 that includes a database query or search expression likely to improve the User's retrieval of vendor item information 33 entries. Alternatively, each state may be coded into a software object that includes the database query method and a search expression likely to retrieve the User's desired vendor item information 33 entries.

PIDs 50 may be included as an attribute in one or more of the database tables, or alternatively tables may be created based upon the similarity of PIDs 50. In either alternative, the state navigable GUI 37 may query a database and request only those vendor item information 33 entries that are associated with the relevant PID 50 to reduce the number of irrelevant database hits. Further, the PIDs 50 may further allow each vendor to easily modify their existing databases by simply adding an additional PID attribute in the tables of their databases.

PIDs 50 are preferably generated by an OSP 1 whose look and feel or taxonomy has been implemented in a state navigable GUI 37. PIDs 50 are associated with vendor item information 33 entries according to similarities and differences between competitive commerce items 34. Moreover, a particular PID 50 may have degrees of difference or similarity to another PID 50 depending upon the quantity and quality of detail in the vendor item information 33.

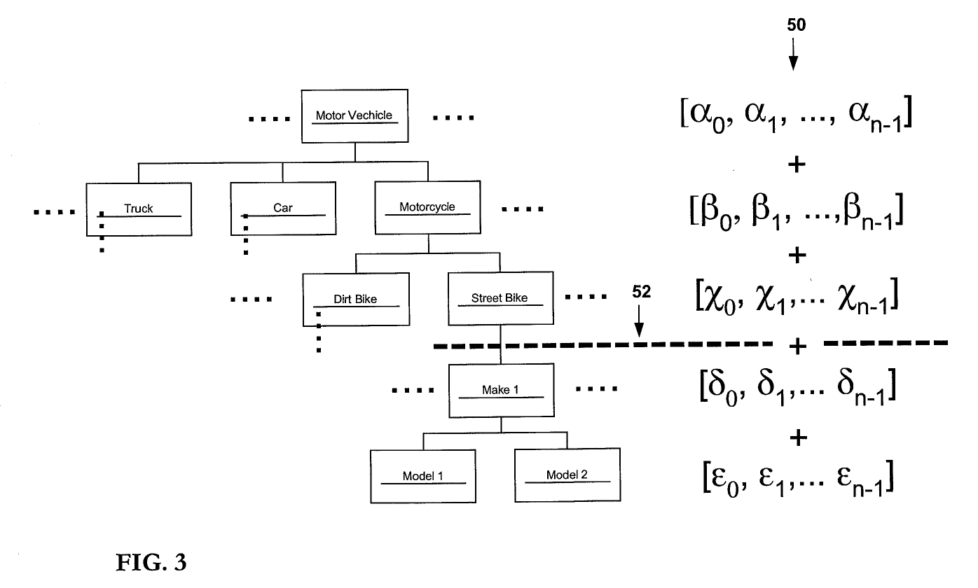

An OSP 1 may choose to implement a methodology for creating PIDs 50 depending upon the complexity of PID 50 that is desired in a search. Thus, as depicted in FIG. 3, PIDs 50 for two different commerce items 34 (e.g. Models of dirt bikes from the same Maker) may have similar vendor item information 33, and hence similar PIDs 50 comprised of like components (e.g. αₙ+βₙ+χₙ+δₙ), but also include a distinguishing PID 50 component (e.g. ε₀ or ε₁). Further, as depicted by the separation line 52, it is contemplated that portions of a particular PID 52, or additional components of the PID 52 could be generated by separate business entities—such as by vendors 3, aggregators 4, and OSPs 1—and combined to form the resultant PID 50. In other embodiments, the OSP 1 generates the entire PID 50 or alternatively, the vendor 3 generates the entire PID 50 based upon the methodology or algorithm communicated by or to the OSPs 1.

PID 50 generation according to the above methodology is preferably automatic and software controlled. In one embodiment, a sorting or filtering algorithm is implemented that parses vendor item information 33 from the vendor's database 32, sorts that item information 33, and assign PIDs 50 to each unit of vendor item information 33 contained in a database. Alternate embodiments contemplate that the vendor item information 33 and the generated PID 50 will be ultimately stored in a database local to the OSP 1, or in the vendor's database remote from the OSP 1. The preferred algorithm to generate PIDs 50 will comprise a sorting or filtering function to detect similarities and differences between vendor item information 33 describing commerce items 34, a PID 50 generating function, and a PID 50 assignment function that associates the generated PIDs 50 and the respective vendor item information 33 within a database. Parsing and sorting algorithms are ordinary in the art and an ordinarily person in the art would be able to create a parsing and sorting algorithm according to the requirements disclosed herein.

The state navigable GUI 37 of the present invention is adapted as a front end to a complete merchant system comprising a dynamic Web page generator to format and a Web page for display within a User's Web browser. The Web page delivered to the User's Web browser is preferably created using a Web page template that presents a listing of the vendor item information entries 33 retrieved from the database. Thus, also included is a database module that communicates with a database to retrieve vendor item information entries 33 from the database and to communicate the page data to the dynamic Web page generator, wherein the retrieved page data corresponds to the PID 50 request initiated from the state navigable GUI 37 that adopts the online look and feel of the OSP 1.

Although the invention has been described in detail with reference to particular preferred embodiments, persons possessing ordinary skill in the art to which this invention pertains will appreciate that various modifications and enhancements may be made without departing from the spirit and scope of the claims that follow.

What is claimed is:

1. A merchant comparison system for an online merchant system, with access to at least one database that includes vendor item information entries reflecting commerce items available for purchase, comprising:
an algorithm for generating product identifiers for association and storage with the vendor item information entries in the database, the product identifiers reflecting similarities in vendor item information entries;
a graphical user interface that adopts an online entities existing trade dress and having navigable states that are represented in a user's Web browser using the online entity's previously developed commerce item taxonomy, each navigable state being further linked to a database query command that includes at least one of the previously associated product identifiers;
a database access and retrieval function that interfaces with the graphical user interface to accept database query commands and retrieve the vendor item information entries associated with the product identifiers; and
a Web page display generator function based upon a Web page template that formats the retrieved vendor item information entries for display in the user's Web browser.

2. The merchant comparison system in claim 1 wherein,
the software module for generating product identifiers for association with the vendor item information entries in the database generates product identifiers that also reflect the differences in vendor item information entries.

3. The merchant comparison system in claim 1 wherein,
the commerce item taxonomy is mapped onto a hierarchical ordering of commerce item categories.

4. The merchant comparison system in claim 3 wherein,
the hierarchical ordering of commerce item categories comprises a tree structure having parent, sibling, and child classes of commerce item categories.

5. The merchant comparison system in claim 1 wherein,
the graphical user interface also includes a text input field, the contents of which are combinable with the database query commands.

6. The merchant comparison system in claim 1 wherein,
the product identifiers are associated with the vendor item information entries as an attribute in a table containing vendor item information entries.

7. The merchant comparison system in claim 1 wherein,
the product identifiers function as identifiers for tables within the database.

8. The merchant comparison system in claim 1 wherein,
the database is under the control of an online business entity selected from the group of entities consisting of; a vendor, an online service provider, or an eCommerce aggregator.

9. The merchant comparison system in claim 1 wherein,
the online business is selected from the group of entities consisting of; a vendor, an online service provider, or an eCommerce aggregator.

10. The merchant comparison system in claim 1 wherein,
the algorithm for generating product identifiers automatically generates product identifiers according to the previously developed commerce item taxonomy, the algorithm including the steps of,
parsing the vendor item information entries in the database to determine matches between the vendor item information entries and instances of the commerce item taxonomy, and
generating a product identifier for association and storage with the vendor item information entry within the database.

11. A graphical user interface for a online merchant system, the online merchant system having access to a database that includes vendor information entries that have been previously associated with product identifiers, the graphical user interface comprising:
a plurality of navigable states, the navigable states represented by elements of an online entity's trade dress that are encoded into hyperlinks for display on a Web browser, at least a portion of the navigable states associated with database access and retrieval programming, the database access and retrieval programming including at least one product identifier; and
a vendor comparison utility that compiles and formats retrieved vendor information entries for display on a Web browser.

12. The graphical user interface in claim 11 wherein,
the elements of an online entity's trade dress comprise elements of a previously existing taxonomy used in previously existing Web pages in the online entity's Web site.

13. The graphical user interface in claim 11 wherein,
the navigable states are represented on a Web browser as a hierarchical tree structure comprising broad commerce item categories relative to narrower commerce item categories, the transition between navigable states initiated by a user's navigation via hyperlinks.

14. The graphical user interface in claim 11 wherein,
the product identifiers reflect similarities in item information entries existing in the database.

15. The graphical user interface in claim 14 wherein,
the product identifiers further reflect differences in item information entries existing in the database.

16. The graphical user interface in claim 11 wherein,
the elements of an online entity's trade dress comprise navigating characteristics previously used in existing Web pages in the online entity's Web site.

17. The graphical user interface in claim 11 wherein,
the elements of an online entity's trade dress comprises both a previously existing taxonomy and navigating characteristics previously used in existing Web pages in the online entity's Web site.

18. A method of facilitating retrieval of commerce item information entries in at least one database, comprising:
generating product identifiers for association with each item information entry in the database; and
incorporating the product identifiers within database access and retrieval programming of a graphical user interface that adopts an online entity's previously existing online trade dress including the taxonomy and navigation characteristics.

19. The method of claim 18 wherein,
the product identifiers reflect similarities in the commerce item information entries.

20. The method of claim 19 wherein,
the product identifiers further reflect differences in the commerce item information entries.

21. The method of claim 18 wherein,
the at least one database comprises a plurality of distinct vendor databases modified to associate product identifiers with the commerce item information entries.

22. The method of claim 18 wherein,
the at least one database comprises a composite database comprised of commerce item information entries from a plurality of distinct vendor databases and subsequently associated with product identifiers in the composite database.

23. The method of claim 18 wherein,
the graphical user interface is state navigable, the navigable states represented by elements of the online entity's trade dress that are encoded into hyperlinks for display on a Web browser, at least a portion of the navigable states associated with database access and retrieval programming, the database access and retrieval programming including at least one product identifier.

24. The method of claim 18 wherein,
the navigable states are represented on a Web browser as a hierarchical tree structure comprising broad commerce item categories relative to narrower commerce item categories, the transition between navigable states initiated by a user's navigation via hyperlinks.

25. The method of claim 18 wherein,
generating product identifiers comprises generating product identifiers according to the previously developed taxonomy, the algorithm including the steps of,
parsing the vendor item information entries in the database to determine matches between the vendor item information entries and instances of the taxonomy, and
generating a product identifier for association and storage with the vendor item information entry within the database.
